(19) United States
(12) Patent Application Publication
(10) Pub. No.: US 2015/0358509 A1
(43) Pub. Date: Dec. 10, 2015

(54) VEHICLE BACKUP CAMERA DEBRIS SHIELD

(71) Applicant: JENNIFER DAWN AUSTIN, Anaconda, MT (US)

(72) Inventor: JENNIFER DAWN AUSTIN, Anaconda, MT (US)

(21) Appl. No.: 14/296,873

(22) Filed: Jun. 5, 2014

(51) Int. Cl. H04N 5/225

(52) U.S. Cl. CPC H04N 5/2252

(57) ABSTRACT

Some embodiments of the present disclosure include a device for protecting a backup camera in a vehicle. The device may include a retractable semicircular shield configured to cover a backup camera in a vehicle when the vehicle is in any operation state other than reverse. The shield may be operatively connected to a camera activation system in the vehicle, wherein the shield is configured to retract into an area of the vehicle proximate to the backup camera when the camera activation system is activated, such as when the vehicle is put into reverse.

### BACKGROUND

The embodiments herein relate generally to vehicle accessories, and more particularly, to a debris shield for the back-up camera in a vehicle.

Many vehicles are now manufactured with back-up cameras that display a live-feed video of the area behind the vehicle on a screen proximate to the driver when the vehicle is in reverse. Unfortunately, the lens of the back-up camera is always exposed to the elements and tends to get dirty. Backup cameras are only useful if the camera lens is clean; a dirty backup camera lens is unsafe and useless. Nothing currently exists to keep the backup camera clean and free of dirt and debris.

Therefore, what is needed is debris shield for protecting the backup camera lens in a vehicle while also allowing the backup camera to function properly.

### SUMMARY

Some embodiments of the present disclosure include a device for protecting a backup camera in a vehicle. The device may include a retractable semicircular shield configured to cover a backup camera in a vehicle when the vehicle is in any operation state other than reverse. The shield may be operatively connected to a camera activation system in the vehicle, wherein the shield is configured to retract into an area of the vehicle proximate to the backup camera when the camera activation system is activated, such as when the vehicle is put into reverse.

### BRIEF DESCRIPTION OF THE FIGURES

The detailed description of some embodiments of the invention is made below with reference to the accompanying figures, wherein like numerals represent corresponding parts of the figures.

FIG. 1 is a schematic view of one embodiment of the present invention in the deployed position.

FIG. 2 is a schematic view of one embodiment of the present invention in the retracted position.

FIG. 3 is a flow chart of one embodiment of the present invention.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to protect a backup camera in a vehicle from dirt and other debris and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Debris Shield

2. Connection to Camera Activation System

The various elements of the vehicle backup camera debris shield for protecting the lens of a vehicle backup camera of the present disclosure may be related in the following exemplary fashion. It is not intended to limit the scope or nature of the relationships between the various elements and the following examples are presented as illustrative examples only.

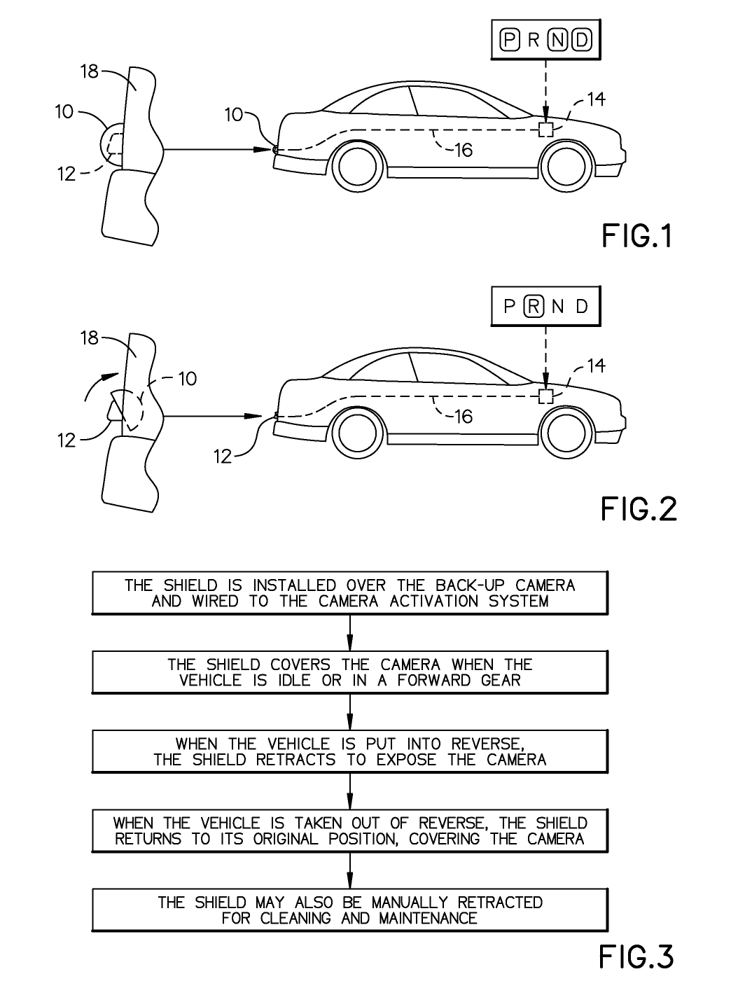

By way of example, and referring to FIGS. 1-3, some embodiments of the backup camera debris shield of the present disclosure comprise a shield 10 configured to protect a backup camera 12 on a vehicle 18 from debris and dirt. In embodiments, the shield 10 may comprise a retractable, semi-circular shield that deploys to cover the backup camera 12, wherein the shield 10 is operatively connected to the camera activation system 14, such that when a user puts the vehicle in park, neutral, drive, or any other setting other than reverse, the shield 10 is deployed, covering and protecting the backup camera 12, as shown in FIG. 1. As shown in FIG. 2, when the camera activation system 14 is activated, such as by putting the vehicle 18 into reverse, the shield 10 may be retracted back into the vehicle 18 to expose the backup camera 12. The back-up camera 12 may display a live-feed video of the area behind the vehicle on a screen proximate to the driver camera activation system 14 is activated without the picture being blocked by the shield 10. In alternate embodiments, the shield 10 may have differing shapes. For example, the shield may be substantially cube shaped or a flat square.

In embodiments, the shield 10 may be operatively connected to the camera activation system by, for example, a wiring system 16. Alternatively, the shield 10 may be operatively connected to the camera activation system using any suitable connection mechanism. Embodiments of the shield 10 may also be manually retractable or deployable for cleaning purposes. The flow chart depicted in FIG. 3 further describes how an embodiment of the shield 10 may function. As described in FIG. 3, the shield 10 may be operatively attached to a retraction mechanism, which may be operatively connected to the camera activation system 14, such that when the camera activation system 14 is activated, the refraction mechanism is also activated causing the shield 10 to retract to expose the backup camera 12. In embodiments, a spring or other mechanism may aid in keeping the shield 10 deployed when the backup camera 12 is inactive.

The shield 10 may be made of any suitable material and, in some embodiments, may be made of plastic. The shield 10 may also have rubberized edges to help keep liquids from entering the area of the vehicle 18 proximate to the backup camera 12. In some embodiments, the shield 10 may be made of a clear, substantially clear, or substantially transparent material such that, if the refraction mechanism fails to operate properly, use of the backup camera 12 will not be impaired. In other embodiments, the shield 10 may be made of an opaque or colored material.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A device for protecting a backup camera in a vehicle, the device comprising:
a shield configured to cover a backup camera in a vehicle,
wherein the shield does not interfere impede the view of the backup camera when the backup camera is activated.

2. The device of claim 1, wherein the shield comprises a retractable shield configured to retract when the backup camera is activated.

3. The device of claim 2, wherein:
the shield is operatively connected to a camera activation system; and
when the camera activation system is activated, the shield retracts into the vehicle and the backup camera displays a live-feed video from behind the vehicle on a screen proximate to a driver in the vehicle.

4. The device of claim 3, wherein the camera activation system is configured to be activated when the driver puts the vehicle in reverse.

5. The device of claim 1, wherein the shield covers and protects the backup camera when the vehicle is in an operation state selected from the group consisting of powered off, in park, in neutral, and in drive.

6. The device of claim 1, wherein the shield comprises a clear, semi-circular piece of plastic.

7. The device of claim 6, wherein the piece of plastic has rubberized edge surfaces.

8. A device for protecting a backup camera in a vehicle, the device comprising:
a retractable semicircular shield configured to cover a backup camera in a vehicle when the vehicle is in any operation state other than reverse,
wherein:
the shield operatively connected to a camera activation system in the vehicle; and
the shield is configured to retract into an area of the vehicle proximate to the backup camera when the camera activation system is activated.

9. The device of claim 8, wherein the camera activation system is configured to be activated when a user puts the vehicle into reverse.

10. The device of claim 8, wherein the shield comprises a clear plastic with rubberized edges.
